(19) United States
(12) Patent Application Publication
(10) Pub. No.: US 2026/0224063 A1
(43) Pub. Date: Aug. 6, 2026

(54) COFFEE GRINDER WITH GRINDING ADJUSTMENT SYSTEM

(71) Applicant: CONTI VALERIO – S.R.L., Sesto Fiorentino (FI) (IT)

(72) Inventor: Maurizio FIORANI, Milano (IT)

(21) Appl. No.: 19/071,945

(22) Filed: Mar. 6, 2025

(30) Foreign Application Priority Data
Feb. 6, 2025 (IT) 102025000002271

(51) Int. Cl. A47J 31/42; A47J 31/52

(52) U.S. Cl. CPC A47J 31/42; A47J 31/525

(57) ABSTRACT

Disclosed is a coffee grinder having a user interface with an initial configuration in which the user can enter an initial dose value to obtain a powder coffee dose and an initial grind value indicative of the grain size of the powder coffee to be obtained, and a smart configuration in which the user can enter a target extraction time that is known based on the coffee recipe to be obtained and a real extraction time given by a coffee machine based on the last extraction of liquid coffee. The control unit of the coffee grinder is configured to calculate a correction value based on a difference between the target extraction time and the real extraction time, and operate the adjusting device based on the correction value.

### CROSS-REFERENCE TO RELATED APPLICATIONS

Not applicable.

### FIELD OF THE INVENTION

The present invention relates to the field of machines for grinding and extracting coffee, and in particular to a coffee grinder with a grinding adjustment system.

### BACKGROUND OF THE INVENTION

Coffee grinders comprising a set of blades for grinding coffee beans to obtain ground coffee are known. These coffee grinders have a system for adjusting the distance between the blades and therefore the grain size of the ground coffee.

Furthermore, in these types of coffee grinders, the user generally sets a grinding time or a weight of a dose that is ideal for a particular recipe. Therefore, the coffee grinder dispenses a dose of ground coffee into a filter holder with a weight substantially equal to that of the desired dose.

The filter holder with the dose of coffee powder is extracted from the coffee grinder and inserted into a coffee machine that comprises a dispensing unit that delivers pressurized hot water to extract the liquid coffee.

It should be noted that the quality of the liquid coffee depends on the extraction time. In fact, each recipe has a specific ideal extraction time. However, the extraction time depends on the grain size of the coffee powder.

If the real extraction time is longer than the ideal extraction time, it means that the grain size of the coffee powder is too fine and the water stagnates in the dose, burning the coffee. On the contrary, if the real extraction time is shorter than the ideal extraction time, it means that the grain size of the coffee powder is too coarse and the water passes quickly through the dose without retaining the coffee's aromas.

Coffee machines generally have a timer that measures the extraction time and a display that shows the extraction time. By way of example, the extraction time can be measured as the time after which the machine stops dispensing pressurized hot water because a given volume of water measured by a flow meter of the machine has been dispensed.

Therefore, the user can visually understand if the real extraction time approximates the ideal extraction time in order to possibly intervene on the coffee grinder to adjust the grain size of the coffee powder. However, if the ideal extraction time is not respected during the coffee extraction, the adjustment of the coffee grinder is left to the expertise of the operator who operates the adjusting device, empirically adjusting the distance between the blades.

### SUMMARY OF THE INVENTION

The purpose of the present invention is to eliminate the drawbacks of the prior art, providing a coffee grinder with grinding adjustment system that is capable of precisely and accurately adjusting the grain size of the ground coffee.

Another purpose is to provide such a coffee grinder with grinding adjustment system that is versatile and suitable for being used with any type of coffee extraction machine.

Another purpose is to provide such a coffee grinder with grinding adjustment system that is efficient and reliable.

These purposes are achieved in accordance with the invention with the characteristics of the attached independent claims.

Advantageous embodiments of the invention appear from the dependent claims.

### BRIEF DESCRIPTION OF DRAWINGS

Further features of the invention will become clearer from the following detailed description, which refers to a purely illustrative and therefore non-limiting embodiment thereof, illustrated in the accompanying drawings.

FIG. 1 is a block diagrammatic view illustrating an assembly comprising a coffee grinder according to the invention and a coffee machine.

FIG. 2 is a diagrammatic view illustrating the user interface of the coffee grinder in an initial configuration.

FIG. 3 is a diagrammatic view illustrating the user interface of the coffee grinder in a smart configuration.

FIG. 4 is a block diagram schematically illustrating the connection between the user interface and the control unit of the coffee grinder.

FIG. 5 is a schematic view illustrating the display of the user interface during the adjustment of the grind value.

FIG. 6 is a block diagram illustrating the operating steps of the coffee grinder.

### DETAILED DESCRIPTION OF THE INVENTION

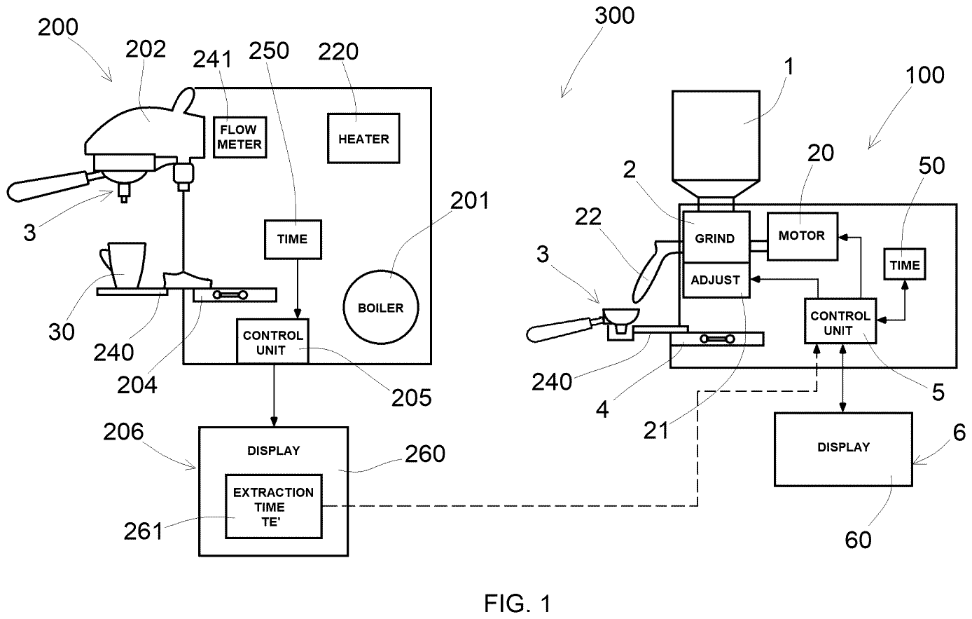

With reference to FIG. 1, an assembly (300) comprising a coffee grinder (100) according to the invention and a coffee machine (200) is illustrated.

The coffee grinder (100) comprises:
a hopper (1) wherein coffee beans are contained,
a grinder unit (2) suitable for grinding the coffee beans to obtain ground coffee,
an electric motor (20) suitable for driving the grinder unit (2),
an adjusting device (21) suitable for adjusting a distance between the blades and therefore the grain size of the ground coffee,
a slide (22) for dispensing the ground coffee,
a support (40) arranged under the slide (22) and suitable for supporting a filter holder (3) intended to be filled with a dose of coffee powder,
a load cell (4) connected to the support (40) to weigh the coffee in the filter holder (3),
a user interface (6) comprising a display (60), buttons (P1-P10) and an adjusting knob (R) to adjust the distance between the blades,
a control unit (5) connected to the electric motor (20), to the adjusting device (21) and to the user interface (6), and
a timer (50) connected to or integrated in the control unit (5).

The display (60) is preferably a touch screen and therefore the keys (P1-P10) are touch keys integrated in the display to implement commands given by the user.

The coffee machine (200) comprises:
a boiler (201) for heating the water,
a dispensing unit (202) suitable for accommodating a filter holder (3) with a dose of ground coffee and dispensing pressurized hot water to dispense the coffee,
a heater (220) connected to the boiler and to the dispensing unit to feed hot water to the dispensing unit suitable for extracting the coffee,
a support (240) arranged under the dispensing unit and suitable for supporting a cup (30) intended to be filled with liquid coffee,
a load cell (204) connected to the support to weigh the liquid coffee in the cup (30) and/or a flow meter (241) to calculate a volume of the dispensed water,
a user interface (206) comprising a display (260),
a control unit (205) connected to the user interface (206), and
a timer (520) connected to or integrated in the control unit (205).

The display (206) of the user interface of the coffee machine comprises a window (260) in which a real extraction time (T_{E}) is displayed, which is equal to the time in which the cup (30) is filled with a dose of liquid coffee.

In order to detect the real extraction time (T_{E}), the timer of the coffee machine (250) generally counts the initial pump activation time and the final time when the pump is stopped.

Alternatively, said time information on the real extraction time (T_{E}) can be obtained using the load cell of the coffee machine (204) which detects the variation in weight in the cup, or using the flow meter (241) which detects the variation in the dispensed water flow.

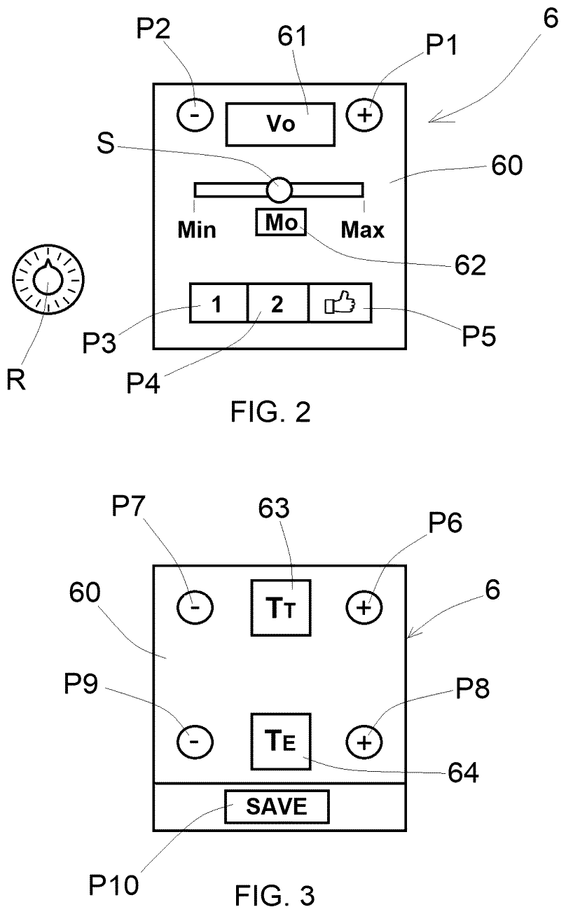

With reference to FIG. 2, the user interface (6) of the coffee grinder comprises an initial configuration in which the user can enter an initial dose value (V₀) to obtain a dose of ground coffee and an initial grind value (M₀) indicative of the grain size of the ground coffee to be obtained and therefore of the distance of the blades.

Buttons (P1, P2) can be used by the user to enter the initial dose value (V₀) which is displayed in a window (61) on the display. The buttons (P1, P2) can be touch-sensitive on the display (60), for example buttons with symbols (+) and (−).

The initial dose value (V₀) can be a grinding time value or a dose weight value.

If the initial dose value (V₀) is equal to a grinding time, the control unit (5) activates the electric motor (20) of the grinder unit by means of the timer (50) for a time equal to the grinding time set by the user.

If the initial dose value (V₀) is equal to an ideal weight of one dose, the load cell (4) detects the real weight of the ground coffee in the filter holder during grinding and the control unit (5) stops the electric motor (20) of the grinder unit when the detected real weight approximates the ideal weight set by the user.

The adjusting knob (R) is shaped like a knob that can be operated by the user to set the initial grind value (M₀) that is displayed in a window (62) of the display. A signal(S) on the display (60) indicates the grind value, which can vary from a minimum value (Min) to a maximum value (Max). By turning the adjusting knob (R), the user varies the grind value (M₀), moving the signal(S) towards the minimum value or the maximum value. The information relating to the initial grind value (M₀) is sent to the adjusting device (21) that regulates the distance of the blades to obtain the desired grain size.

The initial configuration of the user interface of the coffee grinder also comprises a button (P3) to select one dose, a button (P4) to select two doses and a button (P5) to select a smart function. The buttons (P3, P4 and P5) are always implemented as touch buttons in the display (60).

With reference to FIG. 3, the user interface comprises a smart configuration, in which the user can enter a target extraction time (T_{T}) that is known based on the coffee recipe to be obtained and a real extraction time (T_{E}) that the user can read on the display (261) of the coffee machine (200), based on the last extraction carried out.

In the smart configuration, the user interface (6) of the coffee grinder comprises a first pair of buttons (P6, P7) that can be pressed by the user to enter the target extraction time (T_{T}) that is displayed in a window (63) of the display. The buttons (P6, P7) can be touch-sensitive on the display (60), for example buttons with symbols (+) and (−).

In the smart configuration, the user interface (6) comprises a second pair of buttons (P8, P9) that can be pressed by the user to enter the real extraction time (T_{E}) that is displayed in a window (64) of the display. The buttons (P8, P9) can be touch-sensitive on the display (60), for example buttons with symbols (+) and (−). Alternatively, the control unit (205) of the coffee machine can be operationally connected to the control unit (5) of the coffee grinder, either in wired or wireless mode. In this way the real extraction time (T_{E}) detected by the control unit (205) of the coffee machine is sent to the control unit (5) of the coffee grinder, without having to be set manually by the user.

In the smart configuration, the user interface (6) comprises a save button (P10) to save the set time values.

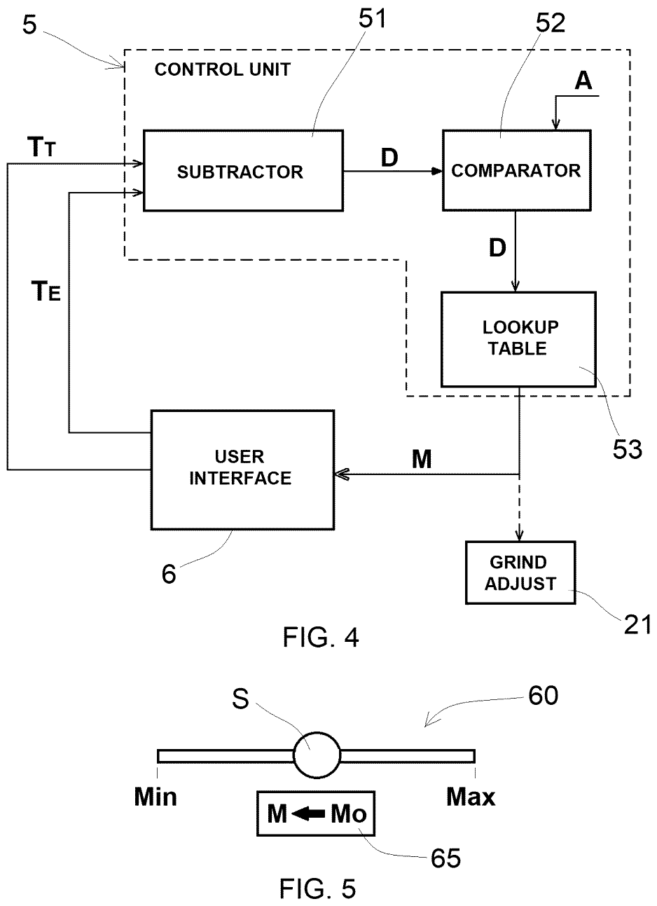

With reference to FIG. 4, the control unit (5) of the coffee grinder is connected both to the user interface (6) of the coffee grinder and to the control unit (205) of the coffee machine, therefore the control unit (5) of the coffee grinder receives the target extraction time (T_{T}) and the real extraction time (T_{E}).

The control unit (5) of the coffee grinder comprises a subtractor (51) that calculates the difference (D) between the target extraction time (T_{T}) and the real extraction time (T_{E}).

A permissible tolerance range (A) is set for the difference (D) between the target extraction time (T_{T}) and the real extraction time (T_{E}). By way of example, such a permissible tolerance range (A) can be set between −2 and +2 seconds.

The control unit (5) comprises a comparator (52) that compares the difference (D) between the target extraction time (T_{T}) and the real extraction time (T_{E}) with the permissible tolerance range (A).

If such a difference (D) is within the tolerance range (A), the initial grind value (M0) is not modified. Instead, if the difference (D) is outside the tolerance range (A), such a difference (D) is sent to a lookup table (53) that relates the difference (D) between the target extraction time (T_{T}) and the real extraction time (T_{E}) with a respective correction value (M) indicative of the correction of the distance between the blades with respect to the initial grind value (M₀). The correction value (M) can be a numerical value, such as +1, +2, +3, . . . −1, 0.2, −3. . .

Obviously, the lookup table (53) may comprise preset values or an algorithm that calculates the correction value (M) based on the difference (D) between the target extraction time (T_{T}) and the real extraction time (T_{E}).

The correction value (M) is sent to the user interface (6). In this way, as shown in FIG. 5, in the initial configuration, a window (65) appears on the display (60) indicating the correction value (M) to be applied with respect to the initial grind value (M₀). Then the user turns the adjusting knob (R) to modify the initial grind value (M₀) based on the correction value (M) shown on the display.

Alternatively, the correction value (M) can be sent directly to the adjusting device (21) that regulates the distance between the blades based on the correction value (M). In this way, the user does not need to use the adjusting knob (R) to set the correction value (M).

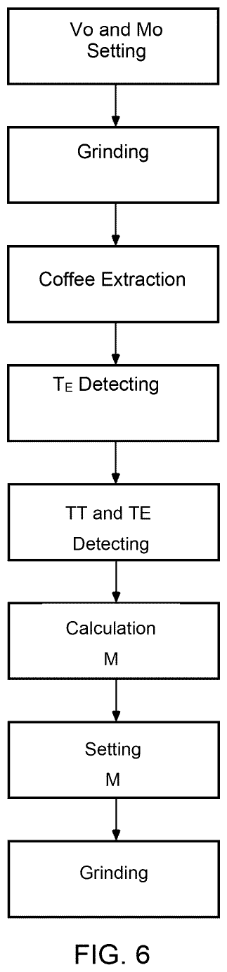

With reference to FIG. 6, the operation of the coffee grinder (100) is described hereinafter.

Initially, in the initial configuration of the coffee grinder, the user sets an initial dose value (V₀) and an initial grind value (M₀) using the user interface (6).

Then the first grinding cycle is started and an initial dose of ground coffee falls into the filter holder (3).

The filter holder (3) with the first coffee dose is removed from the coffee grinder and disposed in the dispensing unit (220) of the coffee machine.

Then the liquid coffee is extracted from the first coffee dose in the filter holder. The coffee machine (200) counts the real extraction time (T_{E}) that appears on the display (260) of the coffee machine to be read by the user. If the coffee machine (200) is connected to the coffee grinder (100), the real extraction time (T_{E}) is sent directly to the coffee grinder.

In the smart configuration, the user sets the target extraction time (T_{T}) and possibly the real extraction time (T_{E}) using the user interface (6).

Then the control unit (5) of the coffee grinder calculates the correction value (M) based on the difference (D) between the target extraction time (T_{T}) and the real extraction time (T_{E}).

If necessary, the user sets such a correction value (M) or the correction value (M) is set automatically and sent to the adjusting device (21) that regulates the distance between the blades.

Subsequently, the second grinding cycle is started and a second dose of ground coffee falls into the filter holder (3).

Obviously, the second dose of ground coffee will have a more suitable grain size compared to the first dose so that the real extraction time (T_{E}) gets closer and closer to the target extraction time (T_{T}). In any case, when the real extraction time (T_{E}) is close to the target extraction time (T_{T}), i.e. within a permissible tolerance range (A), the grind value is not modified and therefore no correction is applied.

Equivalent variations and modifications may be made to the present embodiment of the invention by a technician of the field, which are still within the scope of the invention as expressed by the appended claims.

1. Coffee grinder (100) comprising:
a hopper wherein coffee beans are contained;
a grinder unit suitable for grinding the coffee beans to obtain ground coffee;
an electric motor suitable for driving the grinder unit;
an adjusting device suitable for adjusting a distance between the blades of the grinder unit;
a slide for dispensing the ground coffee from the grinder unit;
a support arranged under the slide and suitable for supporting a filter holder intended to be filled with a dose of coffee powder;
a user interface comprising a display, buttons operable by the user, and an adjusting knob connected to the adjusting device and operable by the user to adjust the distance between the blades;
a control unit connected to the electric motor, to the adjusting device and to the user interface;
wherein said user interface comprises:
an initial configuration in which the user can enter an initial dose value (V₀) to obtain a dose of coffee powder and an initial grind value (M₀) indicative of the particle size of the coffee powder to be obtained; and
a smart configuration in which the user can enter a target extraction time (T_{T}) that is known to the user based on the recipe of the coffee to be obtained and a real extraction time (T_{E}) provided by a coffee machine based on the last extraction of liquid coffee;
wherein the control unit of the coffee grinder is configured to calculate a correction value (M) to correct said initial grind value (M₀) based on a difference (D) between the target extraction time (T_{T}) and the real extraction time (T_{E}), and operate said adjusting device based on said correction value (M).

2. The coffee grinder of claim 1, wherein said correction value (M) calculated by the control unit of the coffee grinder is displayed in a window of the display of the user interface of the coffee grinder, said user-operable adjusting knob being configured to set said correction value (M).

3. The coffee grinder of claim 1, wherein in the initial configuration said user interface comprises:
a first window which displays said initial dose value (V₀) and buttons used to change the initial dose value (V₀); and
a second window which displays said initial grind value (M₀) and a signal(S) indicating the initial grind value (M₀).

4. The coffee grinder of claim 1, wherein said initial dose value (V₀) is a grind time of a dose of coffee powder, and said coffee grinder comprises a timer that counts said grind time.

5. The coffee grinder of claim 1, wherein said initial dose value (V₀) is a weight of a dose of coffee powder and said coffee grinder comprises a load cell that detects the weight of the dose in the filter holder.

6. The coffee grinder of claim 1, wherein in the smart configuration said user interface comprises:
a first pair of buttons operable by the user to enter the target extraction time (T_{T}) that is displayed in a window of the display; and
a second pair of buttons operable by the user to enter the real extraction time (T_{E}) that is displayed in a window of the display.

7. The coffee grinder of claim 1, wherein said control unit comprises:
a subtractor configured to perform a difference (D) between the target extraction time (T_{T}) and the real extraction time (T_{E}); and
a lookup table configured to relate the difference (D) between the target extraction time (T_{T}) and the real extraction time (T_{E}) to a respective correction value (M) that is used to adjust the distance between the blades.

8. The coffee grinder of claim 1, wherein said control unit comprises a comparator configured to compare the difference (D) between the target extraction time (T_{T}) and the real extraction time (T_{E}) with an acceptable tolerance range (A) and not change the initial grind value (M₀) if said difference (D) is within the tolerance range (A).

9. Procedure for grinding coffee with a coffee grinder claim 1, comprising the following steps:
setting an initial dose value (V₀) and an initial grind value (M₀) by means of the user interface in the initial configuration of the coffee grinder;
starting a first grind cycle and grinding of a first dose of coffee powder falling into the filter holder;
removal of the filter holder with the first dose of coffee powder from the coffee grinder and arrangement of the filter holder in a dispensing unit of a coffee machine;
extraction of liquid coffee from the first dose of coffee powder in the filter holder in the coffee machine that counts and displays a real extraction time (T_{E}) that is read by the user;
setting a target extraction time (T_{T}) and a real extraction time (T_{E}) by means of the user interface in the smart configuration of the coffee grinder;
calculation of the correction value (M) based on the difference (D) between the target extraction time (T_{T}) and the real extraction time (T_{E});
setting the correction value (M) in the coffee grinder; and
starting a second grind cycle and grinding of a second dose of coffee powder falling into the filter holder.

10. An assembly comprising:
a coffee machine comprising:
a boiler for heating water;
a dispensing unit suitable for accommodating a filter holder with a dose of ground coffee and dispensing hot water to extract the coffee;
a heater connected to the boiler and to the dispensing unit to feed hot water to the dispensing unit suitable for extracting the coffee;
a support arranged under the dispensing unit and suitable for supporting a cup intended to be filled with liquid coffee;
a user interface comprising a display;
a control unit connected to the user interface, and configured to detect a real extraction time (T_{E}) equal to the time in which the cup is filled with a dose of liquid coffee; and
a coffee grinder comprising:
a hopper wherein coffee beans are contained;
a grinder unit suitable for grinding the coffee beans to obtain coffee powder;
an electric motor suitable for driving the grinder unit;
an adjusting device suitable for adjusting a distance between the blades of the grinder unit;
a slide for dispensing the ground coffee powder from the grinder unit;
a support arranged under the slide and suitable for supporting a filter holder intended to be filled with a dose of coffee powder;
a user interface comprising a display and buttons operable by the user, and an adjusting knob connected to the adjusting device and operable by the user to adjust the distance between the blades, and
a control unit connected to the electric motor, to the adjusting device and to the user interface;
wherein said user interface comprises:
an initial configuration in which the user can enter an initial dose value (V₀) to obtain a dose of coffee powder and an initial grind value (M₀) indicative of the particle size of the coffee powder to be obtained; and
a smart configuration in which the user can enter a target extraction time (T_{T}) that is known to the user based on the recipe of the coffee to be obtained;
wherein the control unit of the coffee machine is operatively connected to the control unit of the coffee grinder and configured to transmit said real extraction time (T_{E}) to the control unit of the coffee grinder; and the control unit of the coffee grinder is configured to calculate a correction value (M) based on a difference (D) between the target extraction time (T_{T}) and the real extraction time (T_{E}), and operate said adjusting device based on said correction value (M).
